(19) United States
(12) Patent Application Publication
(10) Pub. No.: US 2022/0237699 A1
(43) Pub. Date: Jul. 28, 2022

(54) CUSTOMER LEAD ASSESSMENT AND GENERATION TOOL

(71) Applicant: Wells Fargo Bank, N.A., San Francisco, CA (US)

(72) Inventors: Scott Michael Roth, Lancaster, PA (US); Margie Ann Tate, Jacksonville Beach, FL (US); Charlene Mae C. Leong, San Francisco, CA (US); Daniel Reed Smith, West Jordan, UT (US); Susan Joy Whitmore, Hinsdale, IL (US); Marshall C. Ramsey, III, Columbia, SC (US); Swapna Jampala, Salt Lake City, UT (US)

(21) Appl. No.: 16/143,845

(22) Filed: Sep. 27, 2018

(51) Int. Cl. G06Q 40/06; G06Q 20/10; G06Q 40/02; G06N 99/00; G06N 5/02

(52) U.S. Cl. CPC G06Q 40/06; G06Q 20/108; G06F 3/0482; G06N 99/005; G06N 5/022; G06Q 40/02

(57) ABSTRACT

Various examples are directed to computer-implemented systems and methods for providing a customer lead assessment and generation tool for treasury management. A method includes receiving data relating to a customer and customer activity. Product leads are identified for the customer using product lead logic applied to the data, and the product leads are prioritized using priority logic applied to the data for the identified product leads. An image, including information related to at least one prioritized product lead of the customer, is displayed on a graphical user interface (GUI) of a device of a user. An input is received from the user indicative of whether the user will take action on the at least one prioritized product lead of the customer, the input is stored in a memory, and customer data is updated based on the input.

### TECHNICAL FIELD

Embodiments described herein generally relate to cash management services and transaction-related banking and, for example and without limitation, to systems and methods for a customer lead assessment and generation tool.

### BACKGROUND

Financial institutions can provide treasury management (TM) services to customers for the movement of cash as it relates to the payables and receivables process within a company. A financial institution would benefit from leveraging current prospecting opportunities, such as transaction triggers and other activity-based indicators, to identify customers with TM needs and determine appropriate products and holistic solutions to match the customer's objectives and working capital/TM needs.

### BRIEF DESCRIPTION OF THE DRAWINGS

In the drawings, which are not necessarily drawn to scale, like numerals can describe similar components in different views. Like numerals having different letter suffixes can represent different instances of similar components. Some embodiments are illustrated by way of example, and not of limitation, in the figures of the accompanying drawings, in which;

FIG. 1 illustrates an example embodiment of a computer-implemented method for providing a customer lead assessment and generation tool;

FIG. 2A-2B illustrate example embodiments of a user interface for a customer lead assessment and generation tool;

FIG. 3A illustrates an example embodiment of a connection matrix used to display matches for connecting opportunities to current customers for a customer lead assessment and generation tool;

FIG. 3B illustrates an example embodiment of a user interface used to display usage reporting for a customer lead assessment and generation tool;

FIG. 4 illustrates an example embodiment of a user interface used to display a customer spending report for payment optimization; and

FIG. 5 is a block diagram of a machine in the example form of a computer system within which a set of instructions can be executed, for causing the machine to perform any one or more of the methodologies discussed herein.

### DETAILED DESCRIPTION

In the following description, reference is made to the accompanying drawings that form a part hereof, and in which is shown by way of illustration, specific embodiments which may be practiced. These embodiments are described in sufficient detail to enable those skilled in the art to practice the inventive subject matter, and it is to be understood that other embodiments may be utilized and that structural and logical changes may be made without departing from the scope of the present inventive subject matter. The following description of example embodiments is, therefore, not to be taken in a limited sense, and the scope of the present inventive subject matter is defined by the appended claims.

The present subject matter provides a system and method for providing a customer lead assessment and generation tool for treasury management (TM) services provided by a financial services organization or financial institution. The lead assessment and generation tool can be used with a customer relationship management (CRM) software system that enables a user (such as a TM service representative) to manage customer relationships, track meetings, and remind of follow-ups. In various embodiments, the present subject matter assists a user with identifying and prioritizing product opportunities for the customer, and displays the resulting information in a user-friendly manner designed to increase usage of the opportunities and thus provide benefits for both user and customer. Inputs can be received from the user to provide for user feedback and to track usage of the product opportunities.

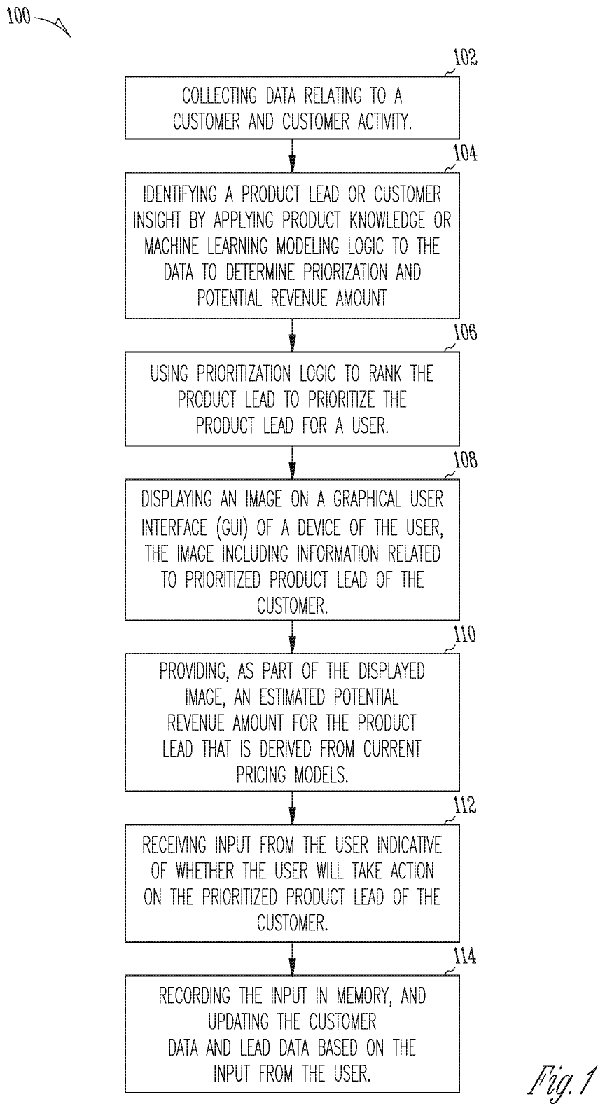

FIG. 1 illustrates an example embodiment of a computer-implemented method 100 for providing a customer lead assessment and generation tool. The method 100 includes collecting data relating to a customer and customer activity, at operation 102. The collected data can include one or more of transaction counts, transaction size, transaction values, types (payment types, receivable types, or transaction types), current product usage, customer demographics including industry of the customer, internal revenue, employee count, credit commitments and revenue of business of the customer. Other types of data, including external data, can be used without departing from the scope of the present subject matter. At operation 104, a product lead (or opportunity) is identified for the customer using product lead logic applied to the collected data. In various embodiments, the product lead logic is derived from specific product knowledge of a plurality of customers or is created based on the current activity of a plurality of customers using statistical and machine learning modeling methods. According to various embodiments, an algorithm is used to determine a most accurate and likely revenue of the product lead based on potential volume for the product and use by other like customers. In one embodiment, several models are used and the most accurate model is chosen and used to display the estimated potential revenue amount. The estimated potential revenue amount is configured to be adjusted using machine learning, in various embodiments. In one embodiment, the estimated potential revenue amount is adjusted on a monthly basis as pricing changes and new customers are added.

The product lead is ranked using prioritization logic to prioritize the product lead for a user, at operation 106. In various embodiments, the prioritization logic uses specific thresholds in one or more of volume, value, industry, or customer type to illustrate product leads with a higher likelihood of being useful to the customer and to the user. An image, including information related to the prioritized product lead of the customer, is displayed on a graphical user interface (GUI) of a device of the user, at operation 108. At operation 110, an estimated potential revenue amount for the product lead is provided as part of the displayed image, the estimated potential revenue amount derived from current pricing models. The estimated potential revenue amount is used to assign a potential value to the product lead, in various embodiments. At operation 112, an input is received from the user indicative of whether the user will take action on the prioritized product lead of the customer. The input is recorded in a memory, and customer data and lead data is updated based on the input, at operation 114.

According to various embodiments, one or more of the product lead logic and the priority logic includes a data analytics tool or a predictive modeling tool. The priority logic includes machine learning used to estimate an opportunity size, in an embodiment. In various embodiments, gamification is used to promote usage and reward the user based on frequency or content of the input. The received data includes information regarding customer enterprise resource planning (ERP) software usage, in one embodiment. In various embodiments, the product lead logic is displayed for the user to make the process more transparent. Identifying product opportunities for the customer includes using activity-based indicators to trigger the identification, in various embodiments. Various examples of the activity-based indictors include account balance variances of the customer, new credit established by the customer, revenue variances of the customer, positive earnings credit rate (ECR) offset of the customer, and pricing pre-tax pre-provision profit earnings (PTPP) triggers. According to various embodiments, identifying a product lead includes identifying a product lead or customer insight by applying product knowledge or machine learning modeling to the data to determine prioritization and potential revenue amount.

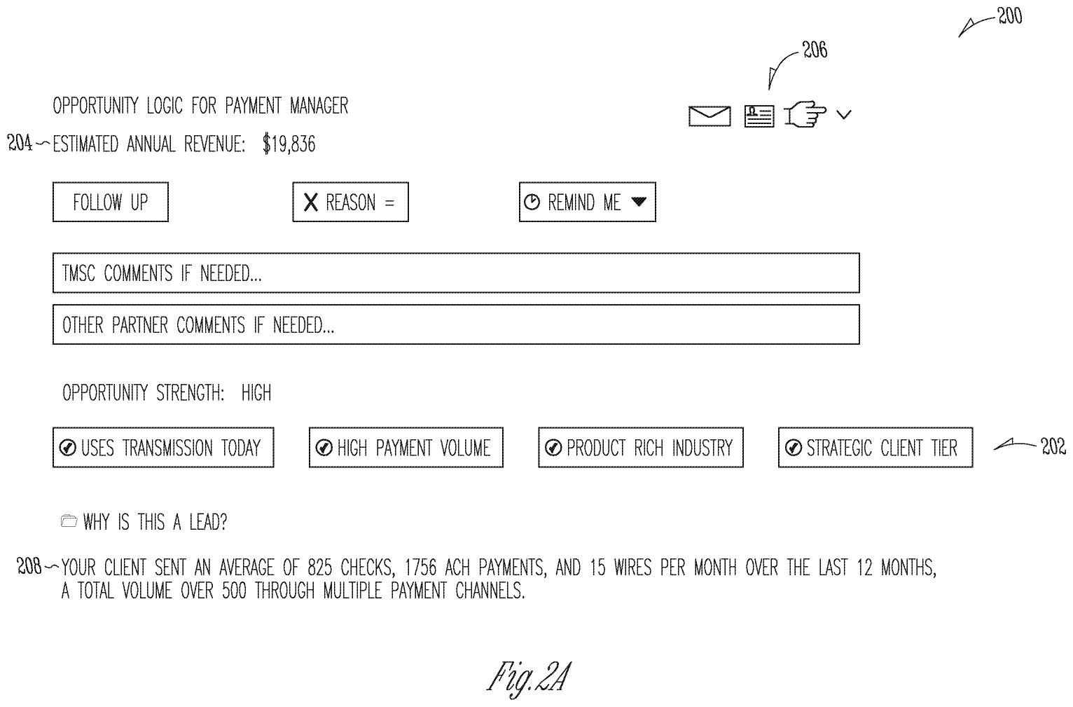

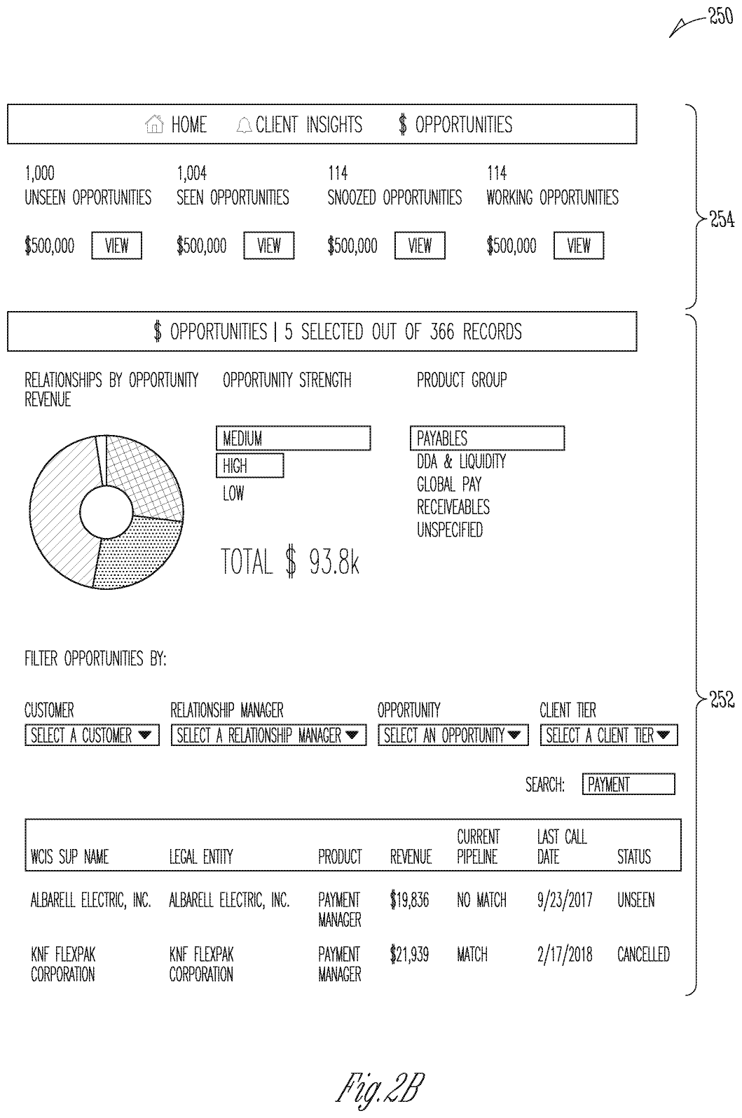

FIG. 2A-29 illustrate example embodiments of a user interface for a customer lead assessment and generation tool. In FIG. 2A, a user interface 200 of the present system displays an identified opportunity (or lead) for an existing customer, including an indication of opportunity strength 202 and estimated annual revenue 204. The opportunity strength 202 provides an indication to the user to help prioritize opportunities within a product set. Logic used to identify the opportunity is driven by underlying customer activity or other current investment volume, in various embodiments. The revenue estimate 204 can leverage machine learning to apply indicated pricing to better estimate opportunity size, in various embodiments. Drop down menus 206 provide options for a user, such as a TM service representative, to enter an input to the system. In the depicted embodiment, the drop down menus 206 include options for the user to indicate whether the user will take action on the opportunity, snooze the display of the opportunity, or cancel the display of the opportunity. Other types of input options or formats can be used without departing from the scope of the present subject matter. In lead logic reveal 208, the user is shown product lead specifics for what triggered the product lead. In various embodiments, lead logic reveal 208 is different for each product type and shows the user what transaction activity, industry information, or usage has driven this product to be identified as a product lead. According to various embodiments, the lead logic reveal 208 can include volumes from other products, volumes of certain payment types, or other usage statistics. The lead logic reveal 208 provides for transparency to the user to aid in the understanding of why this product has been identified as a product lead. In FIG. 2B, another user interface 250 of the present system displays a summary of various identified opportunities for an existing customer, including an opportunity snapshot 252 illustrating various identified opportunities and their respective opportunity strengths. The opportunity snapshot 252 provides an overall summary of a plurality of product leads for the user, and categorizes the leads by revenue, strength and product group. In various embodiments, the opportunity snapshot 252 permits a user to click on a portion of the display illustrating attributes of product leads on an interactive graph, and then filters a displayed table of opportunities by the attributes selected by the user. An opportunity summary 254 illustrating totals of one or more of unseen opportunities, seen opportunities, snoozed/cancelled opportunities, working opportunities, and favorite opportunities. The unseen opportunities are either new, or never revealed, opportunities that the user can review and act upon. Seen opportunities are those that have been previously reviewed by the user, but that the user has not indicated whether action will be taken on them. Snoozed opportunities are those that the user has indicated should be reviewed at a later date, and the user has specified the later date. Working opportunities are those that are actively being pursued by the user. The user interface includes dynamic and compelling infographics illustrating customer benefits to assist the user in implementing the opportunities to benefit the customer.

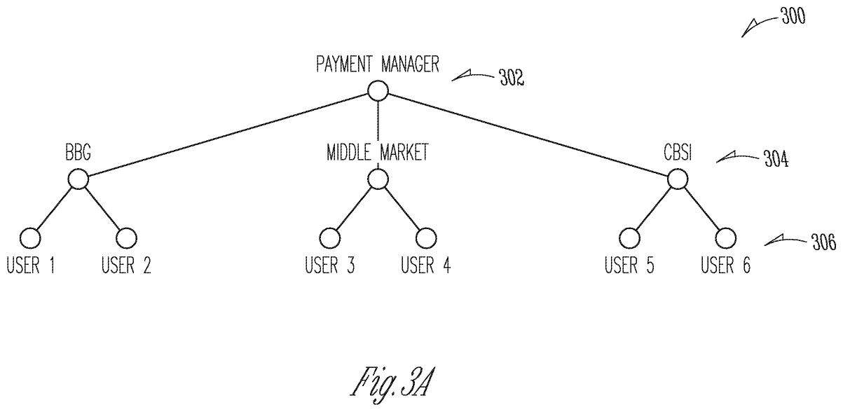

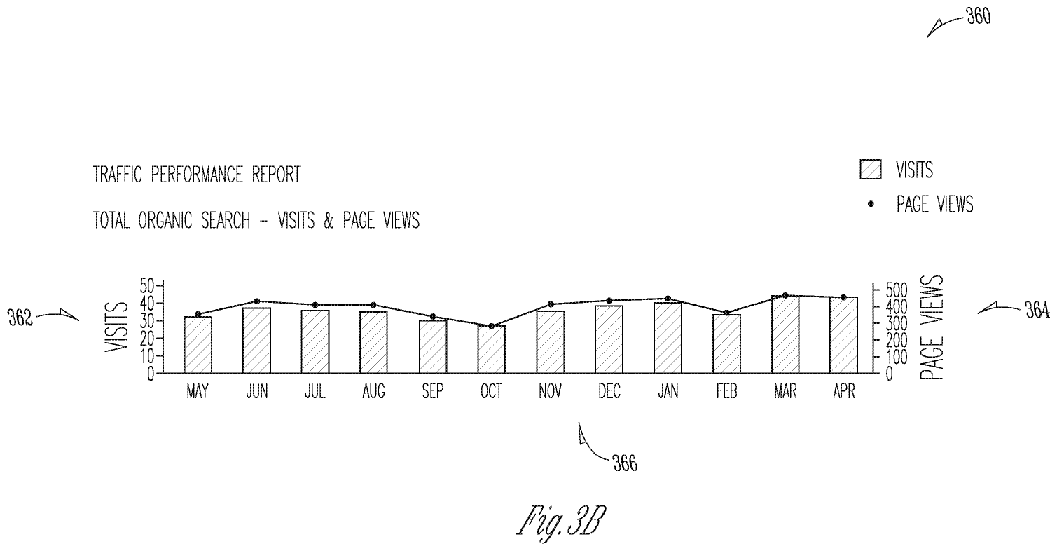

FIG. 3A illustrates an example embodiment of a connection matrix 300 used to display matches for connecting opportunities to current customers for a customer lead assessment and generation tool. For a given lead 302, service representatives 306 within various service centers 304 are identified that can connect and collaborate to act on identified opportunities, in various embodiments. The identified opportunities are connected to recent, similar successes, in various embodiments. According to various embodiments, multiple levels of connections can be made by matching on data points such as products, customer industry and customer enterprise resource planning (ERP) software usage.

FIG. 3B illustrates an example embodiment of a user interface 360 used to display usage reporting for a customer lead assessment and generation tool. The interface 360 includes a display of a graph showing usage of the present system of identified customer opportunities, including number of views 362 and page views 364 on the vertical axis, and time (grouped by month) 366 on the horizontal axis. The interface 360 provides helpful feedback to management and developers to determine usage and effectiveness of the present customer lead assessment and generation tool, in various embodiments. Other displays or reports showing usage metrics can be implemented without departing from the scope of the present subject matter.

According to various embodiments, one or more of the product lead logic and the priority logic includes an analytics tool. One or more of the product lead logic and the priority logic includes a predictive modeling tool, in various embodiments. According to various embodiments, product opportunity logic is displayed for the user for transparency. Various embodiments of the present subject matter include providing priority activity notifications to the user, with information about specific activities or events that have occurred within the customer relationship that can trigger a customer contact. Triggers for priority activity notifications can include: large balance variances of the customer, large revenue variances of the customer, below-standard earnings credit rate (ECR) for the customer, credit commitment of the customer with no TM revenue, or industry-specific usage triggers. Other priority activity notification triggers can be implemented without departing from the scope of the present subject matter.

In various embodiments, the present subject matter combines customer history and product opportunities for display, at relationship level, grouped by payables or receivables. According to various embodiments, the display includes links to access additional relevant data for the user. Data in the display is filterable and sortable by the user, in various embodiments. In various embodiments, a user can set thresholds for opportunity values or strengths to be displayed. Various embodiments employ data analytics to gauge success, and use notifications delivered to the user by priority at login or during a session. Gamification is used to promote usage of the system and reward users for the usage, in various embodiments. Thus, the present subject matter can be used to drive TM service representatives (or other appropriate users) to act upon newly identified opportunities that support their customers' treasury management needs.

Benefits of the present subject matter include, but are not limited to: increased usage and TM success; increased data analytics usage; enhanced surfacing of client engagement opportunities for TM service representatives, delivered proactively and by priority; more accurate and transparent product lead logic; included priority logic; included opportunity strength to help prioritize product opportunities; and enhanced visual, user-friendly outputs offered to TM service representatives.

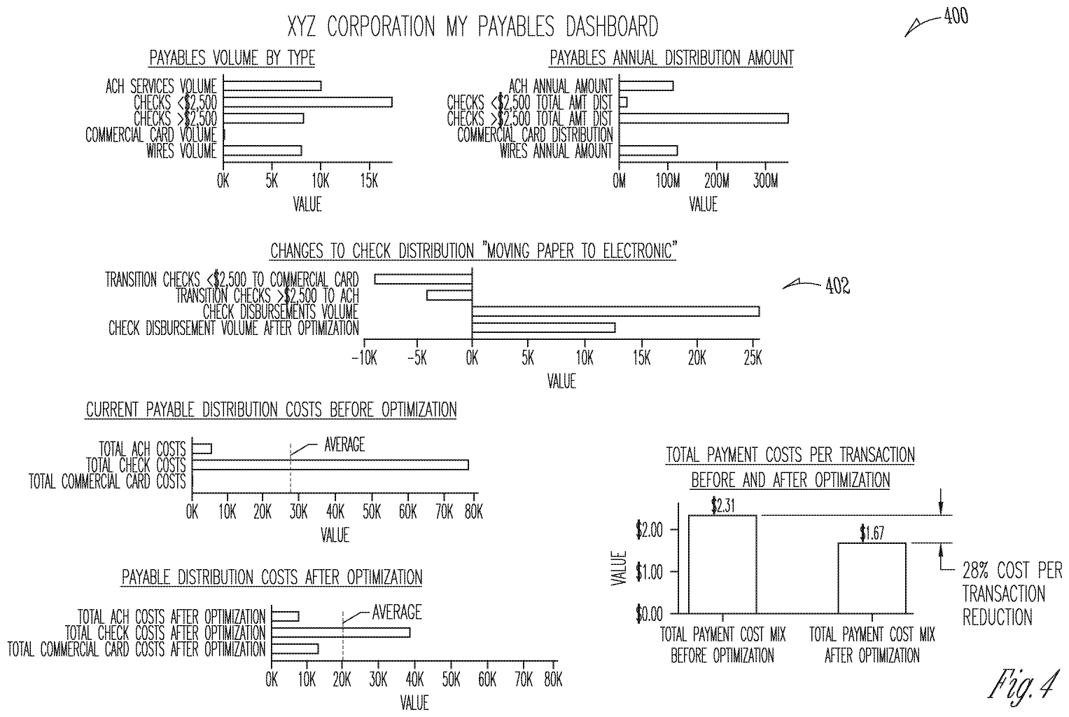

According to various embodiments, the present subject matter further includes a payables dashboard and spending report for customers. FIG. 4 illustrates an example embodiment of a user interface 400 used to display a customer spending report for payment optimization. The spending report includes a graphical representation 402 illustrating how changing from paper to electronic payments will benefit the customer, in various embodiments. The dashboards and reports provide recommended electronic payment solutions to enable payment streamlining within a customer organization. The present subject matter uses an iterative approach to automate and consolidate manual disbursement studies, understand customer spending patterns, grow revenue and provide payment paper-to-electronic (P2E) solutions to show trends, costs and potential savings for the customer. A reusable, nimble solution is used to mine data off-line and upload it to a customer-facing “my spending report” that illustrates the benefit of converting to electronic payments to mitigate check fraud risk. Mined data includes payables and collection trends, spending categories, spending patterns, channel distribution, as well as limits and associated industry standard costs, in various embodiments. Customized benchmarking against customer peer groups is determined and stored, in various embodiments.

Various embodiments of the present subject matter include a system for providing a customer lead assessment and generation tool. The system includes a computing device comprising at least one processor and a data storage device in communication with the at least one processor. The data storage device includes instructions thereon that, when executed by the at least one processor, causes the at least one processor to receive data relating to a customer and customer activity, and identify product leads for the customer using product lead logic applied to the data. The product leads are prioritized using priority logic applied to the data for the identified product leads. An image is displayed on a graphical user interface (GUI) of a device of a user, the image including information related to at least one prioritized product lead of the customer. An input is received from the user indicative of whether the user will take action on the at least one prioritized product lead of the customer. The input is recorded in a memory and customer data is updated based on the input.

In various embodiments, the image further includes information related to customer activity history. The data includes information regarding products or industry of the customer, according to various embodiments. In various embodiments, the computing device can include a laptop, desktop, tablet or cellular telephone. Other computing devices can be used without departing from the scope of the present subject matter.

In various embodiments, a non-transitory computer-readable storage medium is provided. The computer-readable storage medium includes instructions that when executed by computers, cause the computers to perform operations of receiving data relating to a customer, identifying product leads for the customer using product lead logic applied to the data, prioritizing the product leads for the customer using priority logic applied to the data for the identified product leads, displaying an image on a graphical user interface (GUI) of a device of a user, the image including information related to at least one prioritized product lead of the customer, receiving an input from the user indicative of whether the user will take action on the at least one prioritized product lead of the customer, and recording the input in a memory and updating customer data based on the input.

According to various embodiments, a notification is delivered to the user using the GUI. The notification is delivered to the user based on priority of a product lead, in one embodiment. In various embodiments, the notification is delivered to the user at time of login.

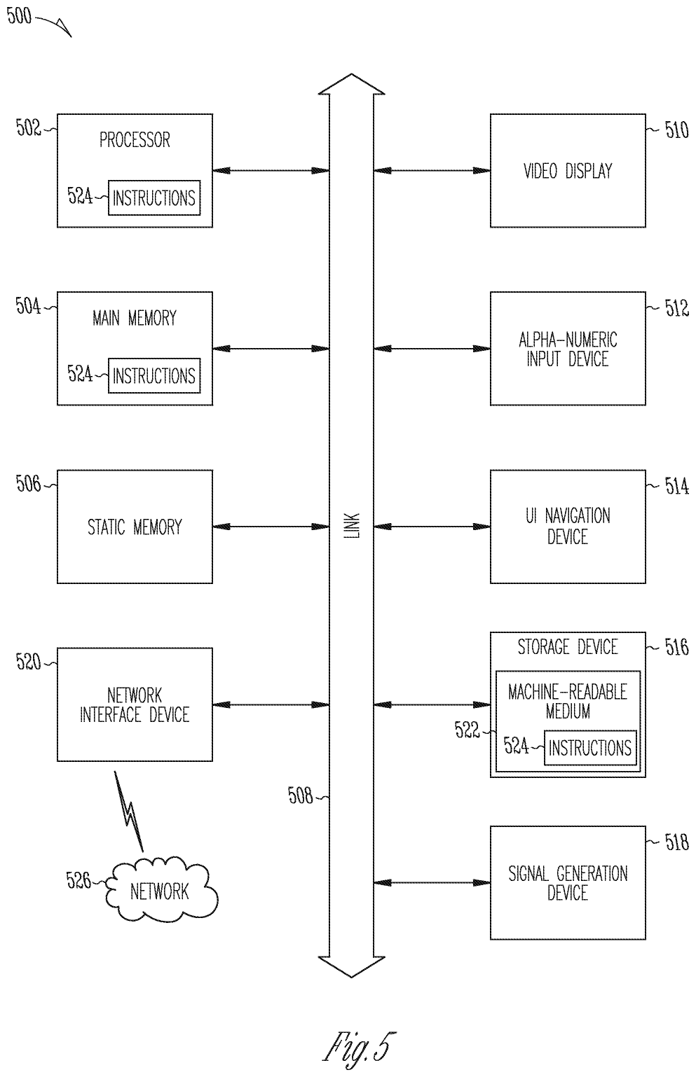

FIG. 5 is a block diagram illustrating a machine in the example form of a computer system 500, within which a set or sequence of instructions can be executed to cause the machine to perform any one of the methodologies discussed herein, according to an example embodiment. In alternative embodiments, the machine operates as a standalone device or can be connected (e.g., networked) to other machines. In a networked deployment, the machine can operate in the capacity of either a server or a client machine in server-client network environments, or it can act as a peer machine in peer-to-peer (or distributed) network environments. The machine can be a personal computer

(PC), a tablet PC, a hybrid tablet, a set-top box (STB), a personal digital assistant (PDA), a mobile or cellular telephone such as a smart phone, a wearable device such as a smart watch, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 can further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 can additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The data storage device 516 includes a machine-readable medium 522 on which is stored one or more sets of data structures and instructions 524 (e.g., software) embodying or utilized by any one or more of the methodologies or functions described herein. The instructions 524 may include a machine learning system or algorithm, and can also reside, completely or at least partially, within the main memory 504, static memory 506, and/or within the processor 502 during execution thereof by the computer system 500, with the main memory 504, static memory 506, and the processor 502 also constituting machine-readable media.

While the non-transitory computer-readable storage medium 522 is illustrated in an example embodiment to be a single medium, the term “machine-readable medium” or “computer-readable medium” can include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions (e.g., instructions 524) for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 can further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone system (POTS) networks, and wireless data networks (e.g., 3G, and 6G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein as embodiments can feature a subset of said features. Further, embodiments can include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A computer-implemented method comprising:
collecting, by a processor of a computer, data relating to a customer and customer activity;
identifying, by the processor, a product lead for the customer using product lead logic applied to the data;
prioritizing, by the processor, the product lead using priority logic applied to the data for the identified product lead;
using, by the processor, machine learning to estimate an opportunity strength of the product lead;
displaying, by the processor, an image on a graphical user interface (GUI) of a device of a user, the image including information related to the prioritized product lead of the customer;
providing, by the processor, as part of the displayed image, an estimated potential revenue amount that is derived from current pricing models, wherein the displayed estimated potential revenue amount is used to assign and display a potential value to the prioritized product lead;
adjusting, by the processor using the machine learning the estimated potential revenue amount based on product volume potential and product use by other customers;
receiving, by the processor, an input from the user indicative of whether the user will take action on the prioritized product lead of the customer;
recording, by the processor, the input in a memory and updating customer data and lead data in the memory based on the input;
categorizing, by the processor, the updated customer data and lead data in the memory based on product group and opportunity strength;
sending, by the processor, a notification based on the categorized updated customer data and lead data in the memory using a plurality of triggers, the plurality of triggers including account balance variances of the customer, new credit established by the customer, revenue variances of the customer, positive earnings credit rate (ECR) offset of the customer, or pricing pre-tax pre-provision profit earnings (PTPP);
dynamically displaying, by the processor, on the GUI an interactive graph related to the product lead;
receiving, by the processor, a selection from the user on a portion of the interactive graph to select attributes of the product lead; and
modifying, by the processor, the display to dynamically provide the opportunity strength of multiple product lead opportunities based on the selection of the attributes by the user.

2. The method of claim 1, wherein one or more of the product lead logic and the priority logic includes a data analytics tool.

3. The method of claim 1, wherein one or more of the product lead logic and the priority logic includes a predictive modeling tool.

4. The method of claim 1, wherein the priority logic includes machine learning used to estimate an opportunity size.

5. The method of claim 1, further comprising:
using, by the processor, gamification to promote usage and reward the user based on frequency or content of the input.

6. The method of claim 1, wherein the data includes information regarding customer enterprise resource planning (ERP) software usage.

7. The method of claim 1, wherein the data includes information related to transaction count, transaction type or transaction size.

8. The method of claim 1, wherein the data includes information related to industry of the customer.

9. The method of claim 1, wherein the data includes information related to revenue of business of the customer.

10. The method of claim 1, wherein the data includes information related to current product usage of the customer.

11. The method of claim 1, wherein the data includes information related to credit commitments of the customer.

12. The method of claim 1, wherein displaying the image includes displaying at least a portion of the product lead logic.

13. The method of claim 1, wherein identifying product opportunities for the customer includes using activity-based indicators to trigger the identification.

14. A system comprising:
a computing device comprising at least one processor and a data storage device in communication with the at least one processor, wherein the data storage device comprises instructions thereon that, when executed by the at least one processor, causes the at least one processor to:
receive data relating to a customer and customer activity;
identify product leads for the customer using product lead logic applied to the data;
prioritize the product leads for the customer using priority logic applied to the data for the identified product leads;
using machine learning to estimate an opportunity strength of the product leads;
display an image on a graphical user interface (GUI) of a device of a user, the image including information related to at least one prioritized product lead of the customer;
provide, as part of the displayed image, an estimated potential revenue amount that is derived from current pricing models, wherein the displayed estimated potential revenue amount is used to assign and display a potential value to the prioritized product lead;
adjust, using the machine learning, the estimated potential revenue amount based on product volume potential and product use by other customers;
receive an input from the user indicative of whether the user will take action on the at least one prioritized product lead of the customer;
record the input in a memory and update customer data in the memory based on the input;
categorize the updated customer data and lead data in the memory based on product group and opportunity strength;
send a notification based on the categorized updated customer data and lead data in the memory using a plurality of triggers, the plurality of triggers including account balance variances of the customer, new credit established by the customer, revenue variances of the customer, positive earnings credit rate (ECR) offset of the customer, or pricing pre-tax pre-provision profit earnings (PTPP);
dynamically display on the GUI an interactive graph related to the product lead;
receive a selection from the user on a portion of the interactive graph to select attributes of the product lead; and
modify the display to dynamically provide the opportunity strength of multiple product lead opportunities based on the selection of the attributes by the user.

15. The system of claim 14, wherein the image further includes information related to customer activity history.

16. The system of claim 14, wherein the data includes information regarding products or industry of the customer.

17. A non-transitory computer-readable storage medium, computer-readable storage medium including instructions that when executed by computers, cause the computers to perform operations of:
receiving data relating to a customer and customer activity;
identifying product leads for the customer using product lead logic applied to the data;
prioritizing the product leads for the customer using priority logic applied to the data for the identified product leads;
using machine learning to estimate an opportunity strength of the product leads;
displaying an image on a graphical user interface (GUI) of a device of a user, the image including information related to at least one prioritized product lead of the customer;
providing, as part of the displayed image, an estimated potential revenue amount that is derived from current pricing models, wherein the displayed estimated potential revenue amount is used to assign and display a potential value to the prioritized product lead;
adjusting, using the machine learning, the estimated potential revenue amount based on product volume potential and product use by other customers;
receiving an input from the user indicative of whether the user will take action on the at least one prioritized product lead of the customer;
recording the input in a memory and updating customer data in the memory based on the input;
categorizing the updated customer data and lead data in the memory based on product group and opportunity strength;
sending a notification based on the categorized updated customer data and lead data in the memory using a plurality of triggers, the plurality of triggers including account balance variances of the customer, new credit established by the customer, revenue variances of the customer, positive earnings credit rate (ECR) offset of the customer, or pricing pre-tax pre-provision profit earnings (PTPP);
dynamically displaying on the GUI an interactive graph related to the product lead;
receiving a selection from the user on a portion of the interactive graph to select attributes of the product lead; and
modifying the display to dynamically provide the opportunity strength of multiple product lead opportunities based on the selection of the attributes of the product lead by the user.

18. The non-transitory computer-readable storage medium of claim 17, further comprising the operations of:
delivering a notification to the user using the GUI.

19. The non-transitory computer-readable storage medium of claim 18, wherein delivering a notification to the user includes delivering the notification to the user based on priority of a product lead.

20. The non-transitory computer-readable storage medium of claim 18, wherein delivering a notification to the user includes delivering the notification to the user at time of login.
